(19) United States
(12) Patent Application Publication
(10) Pub. No.: US 2006/0062619 A1
(43) Pub. Date: Mar. 23, 2006

(54) Image forming apparatus

(75) Inventor: Toru Tanjo, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/229,487

(22) Filed: Sep. 15, 2005

(30) Foreign Application Priority Data
Sep. 22, 2004 (JP) P2004-274715

(51) Int. Cl. G03G 15/00

(52) U.S. Cl. 399/401

(57) ABSTRACT

An image forming apparatus includes an image forming portion that forms an image on a sheet, a fixing portion that fixes the image onto the sheet by passing therethrough, a sheet discharge portion that discharges the sheet that has passed through the fixing portion to a sheet discharge tray, and a pair of switchback rollers that switch back the sheet that has passed through the fixing portion so as to return the sheet to the image forming portion. The switchback rollers are provided between the fixing portion and the sheet discharge portion. The switchback rollers are provided in a sheet discharge path disposed from the fixing portion toward the sheet discharge portion. The switchback rollers are reversely rotated to switch back the sheet when a nip portion between the switchback rollers nips a rear end portion of the sheet that passes toward the sheet discharge portion.

### BACKGROUND OF THE INVENTION

The present invention relates to an image forming apparatus capable of forming an image on both faces of a paper.

As an image forming apparatus capable of forming an image on both faces of a paper, there has been known an image forming apparatus including a fixing portion for causing a paper in which an image is formed thereon by an image forming portion to pass therethrough, thereby fixing the image onto the paper, a pair of paper discharge rollers for discharging the paper passing through the fixing portion onto a paper discharge tray, a switchback dedicated passage for switching back the paper passing through the fixing portion, and a pair of switchback rollers provided in the switchback dedicated passage and serving to switch back the paper passing through the fixing portion and to return the paper to the image forming portion (for example, see JP-A-05-24746 and JP-A-7-257827).

Moreover, there has also been known an image forming apparatus comprising a switchback roller provided in a paper discharge path disposed from the fixing portion toward the paper discharge rollers (for example, see JP-A-2002-244357).

In the image forming apparatus described in each of JP-A-05-24746 and JP-A-7-257827, the switchback dedicated passage for switching back the paper passing through the fixing portion is provided. Furthermore, the switchback rollers are provided in the switchback dedicated passage. For this reason, there is a problem in that the size of the apparatus is increased.

In the image forming apparatus, furthermore, the paper is guided to a separate switchback dedicated passage from the paper discharge path and is thus switched back. Therefore, there is also a problem in that a quick switchback operation cannot be carried out.

In the image forming apparatus described in JP-A-2002-244357, the switchback roller is constituted by a driving roller, a paper discharge side driven roller to be driven in abutment on the driving roller and a switchback side driven roller to be driven in abutment on the driving roller. For this reason, the number of the rollers is increased.

In the image forming apparatus described in JP-A-2002-244357, furthermore, the switchback roller has the structure described above. For the switchback of the paper, therefore, it is necessary to reversely rotate the paper discharge rollers and to deliver the rear end of the paper toward a nip portion between the driving roller and the switchback side driven roller after the rear end of the paper passes through a nip portion between the driving roller and a paper discharge side driven roller.

For this reason, there is also a problem in that the quick switchback operation cannot be obtained.

### SUMMARY OF THE INVENTION

It is an object of the invention to provide an image forming apparatus capable of reducing a size and the number of rollers, and at the same time, freely carrying out a quick switchback operation.

In order to achieve the object, the present invention provides an image forming apparatus, comprising:

an image forming portion that forms an image on a sheet;

a fixing portion that fixes the image onto the sheet by passing therethrough;

a sheet discharge portion that discharges the sheet that has passed through the fixing portion to a sheet discharge tray; and

a pair of switchback rollers that switch back the sheet that has passed through the fixing portion so as to return the sheet to the image forming portion,

wherein the switchback rollers are provided between the fixing portion and the sheet discharge portion;

wherein the switchback rollers are provided in a sheet discharge path disposed from the fixing portion toward the sheet discharge portion; and

wherein the switchback rollers are reversely rotated to switch back the sheet when a nip portion between the switchback rollers nips a rear end portion of the sheet that passes toward the sheet discharge portion.

Preferably, the switchback rollers are reversely rotated to switch back the sheet immediately before the rear end portion of the sheet passes through the nip portion between the switchback rollers.

According to the above configurations, the switchback rollers are provided in the sheet discharge path disposed from the fixing portion toward the sheet discharge rollers. Therefore, the sheet discharge path can be utilized as a switchback passage.

Accordingly, it is not necessary to provide the switchback dedicated passage as in the image forming apparatus described in each of JP-A-05-24746 and JP-A-7-257827. Therefore, it is possible to reduce the size of the apparatus.

Moreover, it is not necessary to take the switchback roller structure as in the image forming apparatus described in JP-A-2002-244357. Therefore, it is possible to reduce the number of the rollers.

According to the image forming apparatus in accordance with the invention, furthermore, it is not necessary to guide the sheet to a separate switchback dedicated passage from the sheet discharge path and to deliver the rear end of the sheet toward a nip portion between a driving roller and a switchback side driven roller after the rear end of the sheet passes through a nip portion between the driving roller and a sheet discharge side driven roller. Consequently, it is possible to obtain a quick switchback operation.

As described above, according to the image forming apparatus in accordance with the invention, a size and the number of the rollers can be reduced, and at the same time, the quick switchback operation can be carried out.

In addition, the switchback rollers are reversely rotated immediately before the rear end of the sheet passes through the nip portion between the switchback rollers. When the sheet is to be switched back, therefore, most parts of the sheet are brought into such a state as to pass through the nip portion between the switchback rollers.

For this reason, the curling state of the sheet curled by the passage through the fixing portion is relieved by the passage of the most parts of the sheet through the nip portion in the switchback rollers. As a result, it is possible to prevent the sheet from being caught or clogged in the switchback which is caused by curling the sheet. Thus, it is possible to obtain a smooth switchback operation.

Preferably, the sheet discharge portion has sheet discharge rollers. It is preferable that, the sheet discharge rollers are corrugation rollers that corrugate the sheet as seen in a discharge direction of the sheet.

However, in the case in which the rear end of the sheet passes through the nip portion between the driving roller and the sheet discharge side driven roller which constitute the switchback roller and the sheet discharge rollers are then rotated reversely to deliver the rear end of the sheet toward the nip portion between the driving roller and the switchback side driven roller as in the image forming apparatus described in JP-A-2002-244357, for example, the sheet is easily moved obliquely when the sheet is to be fed reversely by means of the sheet discharge rollers to be the corrugation rollers if the sheet discharge rollers are constituted by the corrugation rollers.

In the image forming apparatus described in JP-A-2002-244357, accordingly, it is hard to constitute the sheet discharge rollers by the corrugation rollers if the sheet is to be prevented from being moved obliquely in the switchback. To the contrary, there is a problem in that the sheet is moved obliquely in the switchback if the sheet discharge rollers are constituted by the corrugation rollers to discharge the sheet in a desirable state.

On the other hand, according to the invention, it is not necessary to reversely rotate the sheet discharge rollers to deliver the rear end of the sheet toward the nip portion between the driving roller and the switchback side driven roller after the passage of the rear end of the sheet through the nip portion between the driving roller and the sheet discharge side driven roller. Therefore, the sheet discharge rollers can be constituted by the corrugation rollers. Even if the sheet discharge rollers are constituted by the corrugation rollers, moreover, it is possible to prevent the sheet from being moved obliquely in the switchback.

Preferably, the fixing portion has a pair of fixing rollers. The switchback rollers are provided substantially on a line extended from a nip portion between the fixing rollers in a direction perpendicular to a line connecting rotation axes of the fixing rollers.

With such a structure, it is possible to smoothly guide the sheet from the fixing portion to the switchback rollers.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a schematic front view showing an internal structure of an image forming apparatus according to an embodiment of the invention;

FIG. 2 is a partial enlarged view of a switch back portion as shown in FIG. 1;

FIG. 3 is an explanatory view showing a switch back operation;

FIG. 4 is an explanatory view showing the switch back operation;

FIG. 5 is an explanatory view showing the switch back operation; and

FIG. 6 is a view showing a pair of paper discharge rollers as viewed in the direction of the discharge of a paper.

### DETAILED DESCRIPTION OF THE PREFERRED EMBODIMENTS

An embodiment of an image forming apparatus according to the invention will be described below with reference to the drawings.

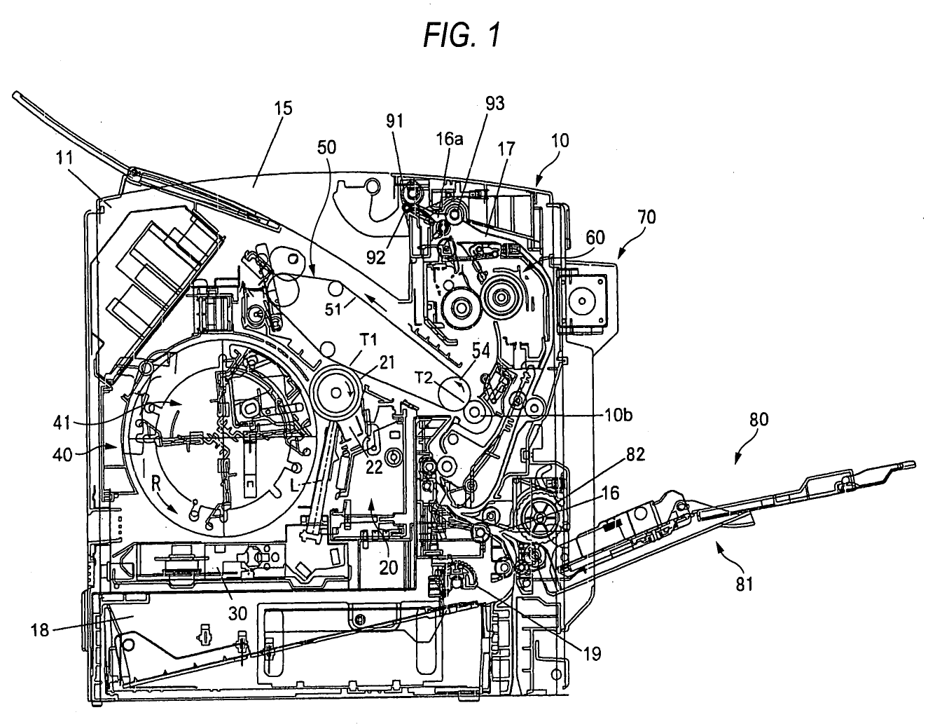

FIG. 1 is a schematic front view showing an internal structure of the image forming apparatus according to an embodiment of the invention.

The image forming apparatus is a color image forming apparatus which can vertically feed a paper having an A4 size (including a letter size) and can form a full color image on both faces thereof, and includes a case 11, an image carrier unit 20 accommodated in the case 11, an exposing unit 30, a developing unit (a developing device) 40, an intermediate transfer unit 50, and a fixing unit (a fixing portion) 60.

The case 11 is provided with a frame of an apparatus body 10 which is not shown and each unit is attached to the frame of the apparatus body 10.

The image carrier unit 20 includes a photosensitive unit 21 having a photosensitive layer on an outer peripheral surface and a corona charger (a scorotron charger) 22 serving as a changing unit for uniformly charging the outer peripheral surface of the photosensitive unit 21. The exposing unit 30 selectively exposes the outer peripheral surface of the photosensitive unit 21 charged uniformly by the corona charger 22 with a laser beam L to form an electrostatic latent image and gives the electrostatic latent image. The electrostatic latent image is developed with a toner by the developing unit 40 to form a visible image (a toner image). A primary transfer portion T1 primarily transfers the toner image onto an intermediate transfer belt 51 of the intermediate transfer unit 50. Furthermore, a secondary transfer portion T2 secondarily transfers the toner image onto a paper serving as a transfer object.

The case 11 includes a delivery path 16 for delivering the paper having an image formed on one of surfaces by the secondary transfer portion T2 toward a paper discharge portion (a paper discharge tray) 15 provided on the upper surface of the case 11 and a return path 17 for switching back the paper delivered toward the paper discharge portion 15 through the delivery path 16 to return the paper toward the secondary transfer portion T2 in order to form an image on the other face of the paper.

A double-sided unit 70 is constituted removably from the apparatus body. By the attachment of the double-sided unit 70, the return path 17 is formed.

A paper feed cassette 18 for laminating and holding a plurality of papers is provided in the lower part of the case 11, and a paper feed roller 19 for feeding the papers one by one toward the secondary transfer portion T2 is provided.

A multipurpose tray 81 constituting a manual paper feed portion 80 is provided below the double-sided unit 70, and a paper feed roller 82 for feeding the papers set into the multipurpose tray 81 one by one is provided in the apparatus body.

The developing unit 40 is a rotary developing unit (a rotary developing device) and a developing unit cartridge (not shown) for each color in which a yellow toner, a cyan toner, a magenta toner and a black toner are accommodated is detachably attached to a rotor body 41. When the rotor body 41 is rotated at a pitch of 90 degrees in the direction of an arrow R, a developing roller (not shown) provided in each developing unit cartridge can be caused to selectively abut on the photosensitive unit 21, thereby developing the surface of the photosensitive unit 21 selectively.

The exposing unit 30 irradiates the laser beam L toward the photosensitive unit 21.

The intermediate transfer unit 50 includes a unit frame which is not shown, a driving roller 54 supported rotatably on the frame, and the intermediate transfer belt 51 wound and stretched around a plurality of driven rollers, and the intermediate transfer belt 51 is circulated and driven in the direction of an arrow which is shown. The primary transfer portion T1 is formed in the abutment portion of the photosensitive unit 21 and the intermediate transfer belt 51, and the secondary transfer portion T2 is formed in the pressure contact portion of the driving roller and a secondary transfer roller 10b provided on the body side.

The secondary transfer roller 10b can approach or separate from the driving roller 54 (that is, the secondary transfer roller 10b can approach or separate from the intermediate transfer belt 51), and the secondary transfer portion T2 is formed when the secondary transfer roller 10b comes in contact with the intermediate transfer belt 51.

When a color image is to be formed, toner images having a plurality of colors are superposed on the intermediate transfer belt 51 in a state that the secondary transfer roller 10b separates from the intermediate transfer belt 51 and the color image is thus formed. Then, the secondary transfer roller 10b abuts on the intermediate transfer belt 51 and the paper is supplied to the abutment portion (the secondary transfer portion T2) so that a color image (a toner image) is transferred (secondarily transferred) from the intermediate transfer belt 51 onto the paper.

The paper having the toner image transferred thereto passes through the fixing portion 60 so that the toner image is molten and fixed, and the paper is then discharged toward the paper discharge tray 15.

The paper is fed selectively to the image forming portion from one of the paper feed cassette 18 and the manual paper feed portion 80.

While a plain paper is usually set steadily into the paper feed cassette 18, various papers are set into the multipurpose tray 81 if necessary. More specifically, a plain paper, a cardboard, a postcard, an envelope, an OHP sheet and other recording materials are properly set into the multipurpose tray 81 whenever a user needs them.

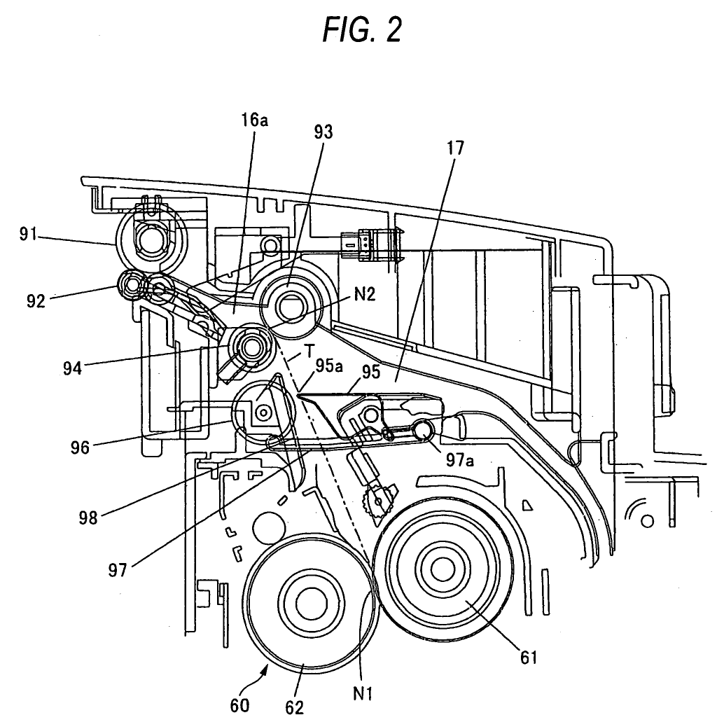

FIG. 2 is an enlarged view showing the switchback portion of the image forming apparatus.

As shown in FIG. 2, the image forming apparatus includes a pair of paper discharge rollers 91 and 92 for discharging a paper passing through the fixing portion 60 onto the paper discharge tray 15 (see FIG. 1), and a pair of switchback rollers 93 and 94 provided between the fixing portion 60 and the paper discharge rollers 91 and 92 and serving to switch back the paper passing through the fixing portion 60 and to return the paper to the image forming portion constituted by the photosensitive unit 21.

The switchback rollers 93 and 94 are provided in a paper discharge path 16a disposed from the fixing portion 60 toward the paper discharge rollers 91 and 92. The switchback rollers 93 and 94 are reversely rotated to switch back the paper immediately before the rear end of the paper passes through a nip portion N2 between the switchback rollers 93 and 94.

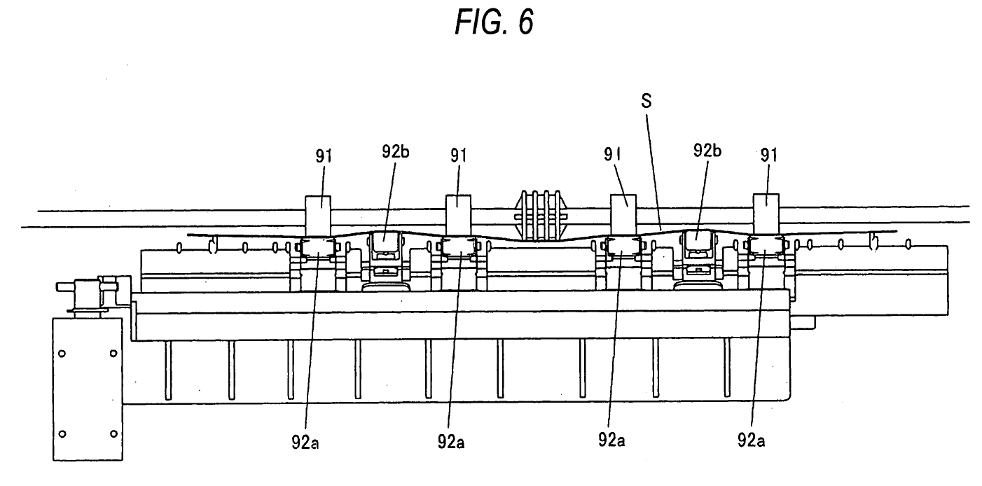

As shown in FIG. 6, the paper discharge rollers 91 and 92 are corrugation rollers for corrugating and stabilizing a paper S to be discharged as seen in the direction of the discharge or as seen in the cross section of the paper.

The rollers 91 are driving rollers. The other roller 92 includes a roller 92a to be driven in abutment on the driving roller 91 and a roller 92b configured to enter a portion between the driving rollers 91 to corrugate the paper S.

As shown in FIG. 2, the fixing portion 60 is constituted by a pair of fixing rollers 61 and 62, and the switchback rollers 93 and 94 are provided on almost an extended line T of a nip N1 seen in rotation axial directions of the switchback rollers 93, 94.

One of the switchback rollers 93 and 94, that is, the roller 93 is a driving roller to be driven by a driving mechanism which is not shown, and the other roller 94 is a driven roller to be rotated in abutment on the driving roller 93.

The switchback rollers 93 and 94 are normally rotated in the discharge of the paper S and are reversely rotated when switching back the paper S.

A branch member 95 for branching the paper discharge path 16a and the return path 17, a guide roller 96 provided opposite to a tip 95a of the branch member 95, and a paper sensor 97 disposed to block the paper discharge path 16a between the branch member 95 and the guide roller 96 are provided between the fixing portion 60 and the switchback rollers 93 and 94. A paper guide 98 is provided on both sides of the guide roller 96 in an axial direction.

The guide roller 96 has no driving mechanism but is provided to prevent a toner from sticking to the paper guide 98 due to the contact of the paper S with the paper guide 98 for a long period of time. The guide roller 96 is freely rotated by the discharge and delivery of the paper S.

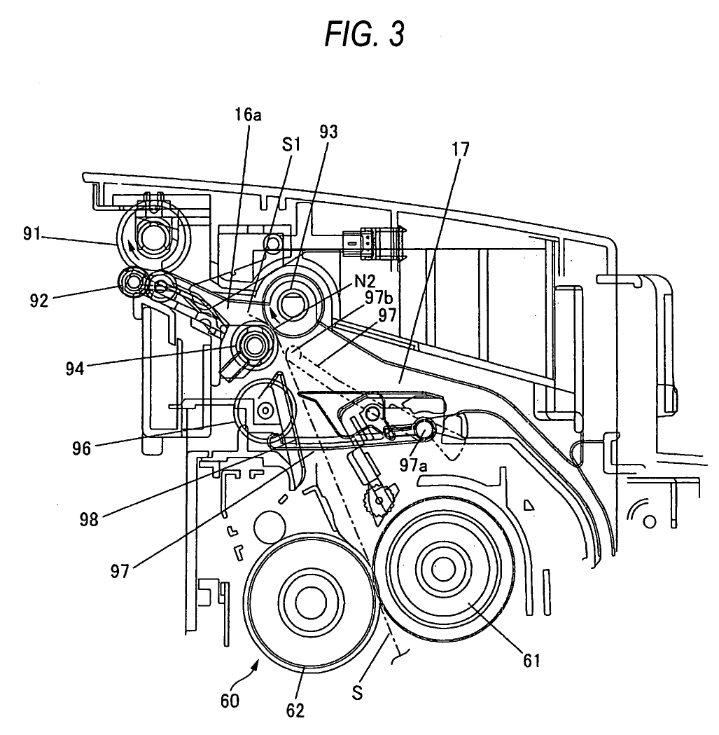

The paper sensor 97 is constituted to be rotatable around an axis 97a, and is pushed by the paper S as shown in a virtual line of FIG. 3 and is thus rotated when the paper S passes therethrough. Consequently, a tip S1 of the paper S can be detected and a detection signal is sent to a controller (not shown) for controlling the operation of the whole image forming apparatus.

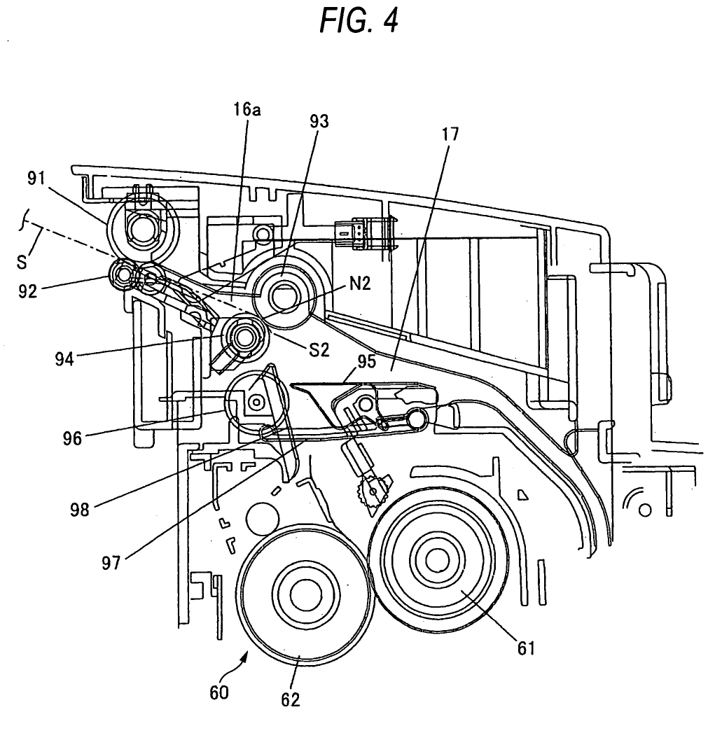

When a rear end S2 of the paper S (see FIG. 4) passes through a tip 97b of the paper sensor 97, moreover, the paper sensor 97 is returned to an original position as shown in a solid line of FIG. 4. Consequently, the passage of the rear end S2 of the paper S can be detected and a detection signal is sent to the controller.

Upon receipt of the detection signal indicative of the passage of the rear end of the paper from the paper sensor 97, the controller reversely rotates the switchback rollers 93 and 94 in a predetermined timing, that is, a timing obtained immediately before the passage of the rear end S2 of the paper S through the nip portion N2 between the switchback rollers 93 and 94, thereby switching back the paper S.

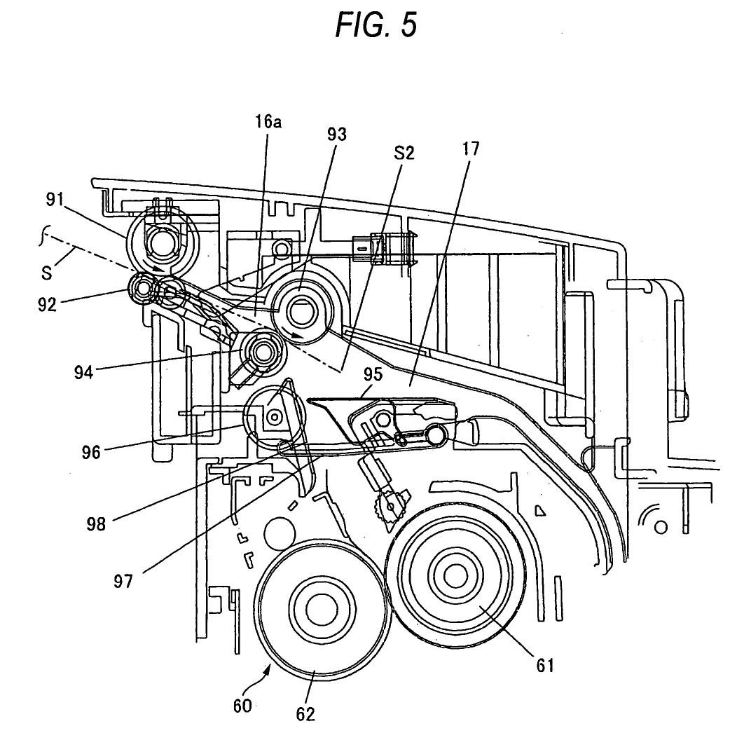

Consequently, the rear end S2 (a tip in the direction of advance) of the paper S is guided to the return path 17 as shown in FIG. 5 and the paper S is returned to the image forming portion through the return path 17 with both sides turned over.

While the switchback rollers 93 and 94 are rotated reversely to switch back the paper S in such a timing that the rear end S2 of the paper S is just interposed in the nip portion N2 between the switchback rollers 93 and 94 in the embodiment, the switchback rollers 93 and 94 may be rotated reversely in a timing obtained immediately before the rear end S2 of the paper S is interposed in the nip portion N2 between the switchback rollers 93 and 94 as shown in FIG. 4.

When the switchback rollers 93 and 94 are rotated reversely, the paper discharge rollers 91 and 92 are also rotated reversely. Since the paper discharge rollers 91 and 92 are the corrugation rollers, however, the paper discharge rollers 91 and 92 do not contribute to the delivery (reverse feed) of the paper S in this case very greatly.

According to the image forming apparatus described above, the following functions and advantages can be obtained.

The image forming apparatus includes the fixing portion 60 for causing the paper S having an image formed thereon in the image forming portion to pass therethrough, thereby fixing the image onto the paper S, the paper discharge rollers 91 and 92 for discharging the paper S passing through the fixing portion 60 onto the paper discharge tray 15, and the switchback rollers 93 and 94 provided between the fixing portion 60 and the paper discharge rollers 91 and 92 and serving to switch back the paper S passing through the fixing portion 60 and to return the paper S to the image forming portion. Further, the switchback rollers 93 and 94 are provided in the paper discharge path 16a disposed from the fixing portion 60 toward the paper discharge rollers 91 and 92 and the switchback rollers 93 and 94 are reversely rotated to switch back the paper S immediately before the rear end S2 of the paper passes through the nip portion N2 between the switchback rollers 93 and 94. Therefore, the paper discharge path 16a can be utilized as a switchback passage.

Accordingly, it is not necessary to provide the switchback dedicated passage as in the image forming apparatus described in each of JP-A-05-24746 and JP-A-7-257827. Therefore, it is possible to reduce the size of the apparatus.

Moreover, it is not necessary to take the switchback roller structure as in the image forming apparatus described in JP-A-2002-244357. Therefore, it is possible to reduce the number of the rollers.

According to the image forming apparatus of this embodiment, furthermore, it is not necessary to guide the paper S to a separate switchback dedicated passage from the paper discharge path 16a and to deliver the rear end of the paper toward the nip portion between the driving roller and the switchback side driven roller after the rear end of the paper passes through the nip portion between the driving roller and the paper discharge side driven roller. Consequently, it is possible to obtain a quick switchback operation.

As described above, according to the image forming apparatus, a size and the number of the rollers can be reduced, and at the same time, the quick switchback operation can be carried out.

In addition, the switchback rollers 93 and 94 are reversely rotated immediately before the rear end S2 of the paper S passes through the nip portion N2 between the switchback rollers 93 and 94. When the paper S is to be switched back, therefore, most parts of the paper S are brought into such a state as to pass through the nip portion N2 between the switchback rollers 93 and 94 (see FIG. 4).

For this reason, the curling state of the paper S curled by the passage through the fixing portion 60 is relieved by the passage of the most parts of the paper through the nip portion N2 between the switchback rollers. As a result, it is possible to prevent the paper from being caught or clogged in the switchback which is caused by curling the paper (see FIG. 5). Thus, it is possible to obtain a smooth switchback operation.

The paper discharge rollers 91 and 92 are constituted by the corrugation rollers for corrugating and stabilizing the paper S to be discharged as seen in the direction of the discharge. Therefore, it is possible to discharge the paper while relieving the curling state of the paper curled by the passage through the fixing portion 60 (see FIG. 6).

If the rear end of the paper passes through the nip portion between the driving roller and the paper discharge side driven roller which constitute the switchback roller and the paper discharge rollers are then rotated reversely to deliver the rear end of the paper toward the nip portion between the driving roller and the switchback side driven roller as in the image forming apparatus described in JP-A-2002-244357, for example, the paper is easily moved obliquely when the paper is to be fed reversely by means of the paper discharge rollers to be the corrugation rollers if the paper discharge rollers are constituted by the corrugation rollers.

In the image forming apparatus described in JP-A-2002-244357, accordingly, it is hard to constitute the paper discharge rollers by the corrugation rollers if the paper is to be prevented from being moved obliquely in the switchback. To the contrary, there is a problem in that the paper is moved obliquely in the switchback if the paper discharge rollers are constituted by the corrugation rollers to discharge the paper in a desirable state.

On the other hand, according to the image forming apparatus in accordance with the embodiment, it is not necessary to reversely rotate the paper discharge rollers to deliver the rear end of the paper toward the nip portion between the driving roller and the switchback side driven roller after the passage of the rear end of the paper through the nip portion between the driving roller and the paper discharge side driven roller. Therefore, the paper discharge rollers 91 and 92 can be constituted by the corrugation rollers. Even if the paper discharge rollers 91 and 92 are constituted by the corrugation rollers, moreover, it is possible to prevent the paper S from being moved obliquely in the switchback.

Also, the switchback rollers 93 and 94 are provided on almost the extended line T of the nip portion N1 seen in the rotation axial direction of the fixing roller pairs 61 and 62 of the fixing portion 60. Therefore, it is possible to smoothly guide the papers from the fixing portion 60 to the switchback rollers 93 and 94.

While the embodiment according to the invention has been described above, the invention is not restricted to the embodiment but changes can be properly made without departing from the scope of the invention.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2004-274715 filed on Sep. 22, 2004, the contents of which are incorporated herein for reference.

What is claimed is:

1. An image forming apparatus, comprising:
an image forming portion that forms an image on a sheet;
a fixing portion that fixes the image onto the sheet by passing therethrough;
a sheet discharge portion that discharges the sheet that has passed through the fixing portion to a sheet discharge tray; and
a pair of switchback rollers that switch back the sheet that has passed through the fixing portion so as to return the sheet to the image forming portion,
wherein the switchback rollers are provided between the fixing portion and the sheet discharge portion;
wherein the switchback rollers are provided in a sheet discharge path disposed from the fixing portion toward the sheet discharge portion; and
wherein the switchback rollers are reversely rotated to switch back the sheet when a nip portion between the switchback rollers nips a rear end portion of the sheet that passes toward the sheet discharge portion.

2. The image forming apparatus according to claim 1, wherein the switchback rollers are reversely rotated to switch back the sheet immediately before the rear end portion of the sheet passes through the nip portion between the switchback rollers.

3. The image forming apparatus according to claim 1, wherein the sheet discharge portion has sheet discharge rollers.

4. The image forming apparatus according to claim 3, wherein the sheet discharge rollers are corrugation rollers that corrugate the sheet as seen in a discharge direction of the sheet.

5. The image forming apparatus according to claim 1, wherein the fixing portion has a pair of fixing rollers; and
wherein the switchback rollers are provided substantially on a line extended from a nip portion between the fixing rollers in a direction perpendicular to a line connecting rotation axes of the fixing rollers.
